(19) United States
(12) Patent Application Publication
(10) Pub. No.: US 2017/0198913 A1
(43) Pub. Date: Jul. 13, 2017

(54) FUEL INJECTION SYSTEM FOR A TURBINE ENGINE

(71) Applicant: SIEMENS AKTIENGESELLSCHAFT, München (DE)

(72) Inventors: James Bertoncello, Charlotte, NC (US); Reinhard Schilp, Winter Park, FL (US); Timothy A. Fox, Hamilton, Ontario (CA); Jacob William Hardes, Charlotte, NC (US)

(21) Appl. No.: 15/326,270

(22) PCT Filed: Aug. 8, 2014
(86) PCT No.: PCT/US2014/050253

§ 371 Date: Jan. 13, 2017

(51) Int. Cl. F23R 3/28; F02C 7/22; F23R 3/34

(52) U.S. Cl. CPC F23R 3/286; F23R 3/346; F02C 7/22; F05D 2220/32

(57) ABSTRACT

A fuel system (10) for a gas turbine engine that improves efficiency by supplying fuel to a primary stage (14) and secondary stage (16) via a common fuel source (18) is disclosed. The fuel system (10) may be formed from first and second primary injector assembly stages (20, 22) and a first premix injector assembly stage (24) positioned upstream from a combustor chamber (26), whereby the first premix injector assembly stage (24) is a secondary injector system. The second primary stage (22) and the first premix stage (24) may be in fluid communication with the same fuel source (18) to eliminate duplicative components found within systems where fuel is supplied individually to the second primary stage and the first premix stage. In at least one embodiment, the second primary injector assembly stage (22) and the first premix injector assembly stage (24) may each be in communication with a fuel manifold (28) configured to supply more fuel to the second primary stage (22) than the first premix stage (24).

### FIELD OF THE INVENTION

This invention is directed generally to turbine engines, and more particularly to fuel systems for turbine engines.

### BACKGROUND

Typically, gas turbine engines include a plurality of injectors for injecting fuel into a combustor to mix with air upstream of a flame zone. The fuel injectors of conventional turbine engines may be arranged in one of at least three different schemes. Fuel injectors may be positioned in a lean premix flame system in which fuel is injected in the air stream far enough upstream of the location at which the fuel/air mixture is ignited that the air and fuel are completely mixed upon burning in the flame zone. Fuel injectors may also be configured in a diffusion flame system such that fuel and air are mixed and burned simultaneously. In yet another configuration, often referred to as a partially premixed system, fuel injectors may inject fuel upstream of the flame zone a sufficient distance that some of the air is mixed with the fuel. Partially premixed systems are combinations of a lean premix flame system and a diffusion flame system.

During operation, fuel is injected into the combustion chamber through the injectors into three or four stages, such as a pilot nozzle, an A-stage, a B-stage, and a C-stage (for configurations having tophat injection or pilot premix features). The pilot nozzle may also be formed from premix and diffusion stages. The pilot nozzle provides fuel that is burned to provide a mini-diffusion flame injector and also provides stability for the premixed A-, B-, and C-stages. Often turbine engines are run using high levels of airflow, thereby resulting in lean fuel mixtures with a flame temperature low enough to prevent the formation of a significant amount of NOₓ. However, because lean flames have a low flame temperature, lean flames are prone to high CO production. And because excess CO production is harmful, a need exists to limit CO emissions.

Turbine engines often operate at higher fuel to air ratios at partial loads rather than at full load. However, turbine engines are designed for full loads. Thus, nozzles designed to run at full load run excessively lean at partial loads. Inlet guide vanes (IGVs) can be used to reduce air flow through the engine at partial loads, thereby increasing the fuel to air ratio and enabling the engine to operate more efficiently through a larger range of loads. However, IGVs may only be used to restrict air flow a limited amount.

Fuel staging is used to control fuel injection at loads below which IGVs may be used effectively. Fuel staging is a process of emitting fuel from less than all of the injectors in a fuel system. By reducing the number of injectors through which fuel is ejected, the amount of fuel passed through the injectors during operation of the turbine engine at partial loads is increased, and thus, burnout is improved. However, using fuel staging requires duplicative auxiliary piping, orifice fuel flow meters, pressure sensors, temperature sensors, and sensors for determining pressure differences. Furthermore, a conventional c-stage fuel injection is currently achieved via a formed and welded ring installed within a combustor together with a c-stage fuel manifold. The conventional c-stage fuel injection system typically includes a complicated assembly of several welded components that are custom fit during assembly. The challenging assembly and disassembly procedure for this design is believed to be a contributing factor in several significant field issues which have resulted in failure of these components.

### SUMMARY OF THE INVENTION

A fuel system for a gas turbine engine that improves efficiency by supplying fuel to a main stage and secondary stage via a common fuel source is disclosed. The fuel system may be formed from first and second primary injector assembly stages and a first premix injector assembly stage positioned upstream from a combustor chamber, whereby the first premix injector assembly stage is a secondary injector system. The second primary injector assembly stage and the first premix injector assembly stage may be in fluid communication with the same fuel source to eliminate duplicative components found within systems where fuel is supplied individually to the second primary injector assembly stage and the first premix injector assembly stage. The fuel system may also be configured such that first premix injector assembly stage need not be formed from custom fit parts installed during engine assembly. Rather, the fuel system may be formed without such components. In at least one embodiment, the second primary injector assembly stage and the first premix injector assembly stage may each be in communication with a fuel manifold configured to supply more fuel to the second primary injector assembly stage than the first premix injector assembly stage.

The fuel system may include a first primary injector assembly stage comprising at least one injector positioned in a combustor, whereby the first primary injector assembly stage is a first main injector system. The fuel system may also include a second primary injector assembly stage comprising at least one injector positioned in the combustor, whereby the second primary injector assembly stage is a second main injector system. The fuel system may include a first premix injector assembly stage formed from one or more injectors positioned in the combustor and in fluid communication with a fuel source that also supplies fuel to at least the second primary injector assembly stage. The first premix injector assembly stage may be a secondary injector system. The first premix injector assembly stage and the second primary injector assembly stage may be coupled together such that the fuel system is capable of emitting fuel into the combustor of the turbine engine via the first premix injector assembly stage and the second primary injector assembly stage simultaneously. In at least one embodiment, the second primary injector assembly stage may be in fluid communication with a fuel supply manifold, and the first premix injector assembly stage may be in fluid communication with the fuel supply manifold. The fuel supply manifold may be configured to supply less fuel to the first premix injector assembly stage than the second primary injector assembly stage.

The first premix injector assembly stage may include one or more fuel injectors extending into a combustor chamber within the combustor. In at least one embodiment, the fuel injector may be a fuel injector peg that is in fluid communication with the fuel supply manifold. The fuel injector peg may extend from a support housing containing the fuel supply manifold. In at least one embodiment, the fuel injector peg may include at least six fuel injector pegs extending from the support housing containing the fuel supply manifold into the combustor chamber. The fuel injector pegs may be positioned in a circumferential array extending downstream from the support housing. The fuel injector pegs may be separated by injectors forming the second primary injector assembly stage.

One or more injectors of the first premix injector assembly stage may be positioned upstream from a fuel swirler. A downstream end of one or more of the injectors of the first premix injector assembly stage may terminate upstream of a downstream end of the injectors of the second primary injector assembly stage.

An advantage of the fuel system is that the fuel system can combine primary and secondary fuel injector assembly stages while maintaining acceptable engine dynamics and NOx emissions, thereby eliminating the need for duplicative auxiliary piping, orifice fuel flow meter, pressure sensor, temperature sensor, and sensors for determining pressure differences.

Another advantage of the fuel system is that the first premix injector assembly stage forming the secondary fuel injector assembly stage may be easily incorporated into the support housing without the need for creating custom fit during installation for components, manifolds, etc. for conventional fuel feed systems for secondary fuel injector systems.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional view of a portion of a turbine engine including a fuel system.

FIG. 2 is a perspective view of a support housing with primary and secondary fuel stages.

FIG. 3 is a perspective view of the fuel system removed from a combustor.

### DETAILED DESCRIPTION OF THE INVENTION

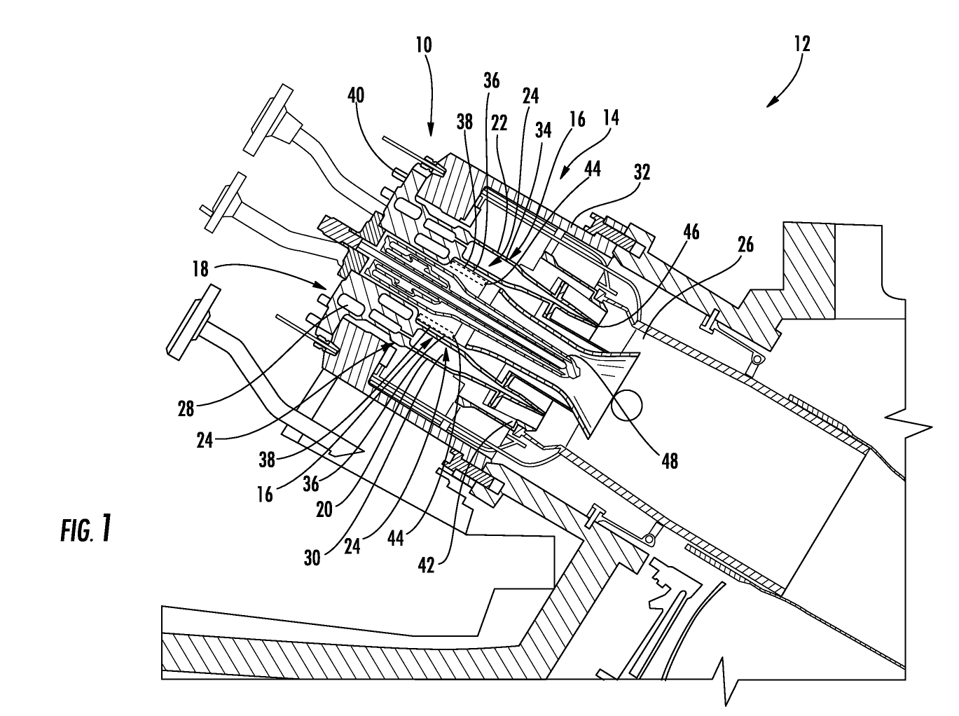

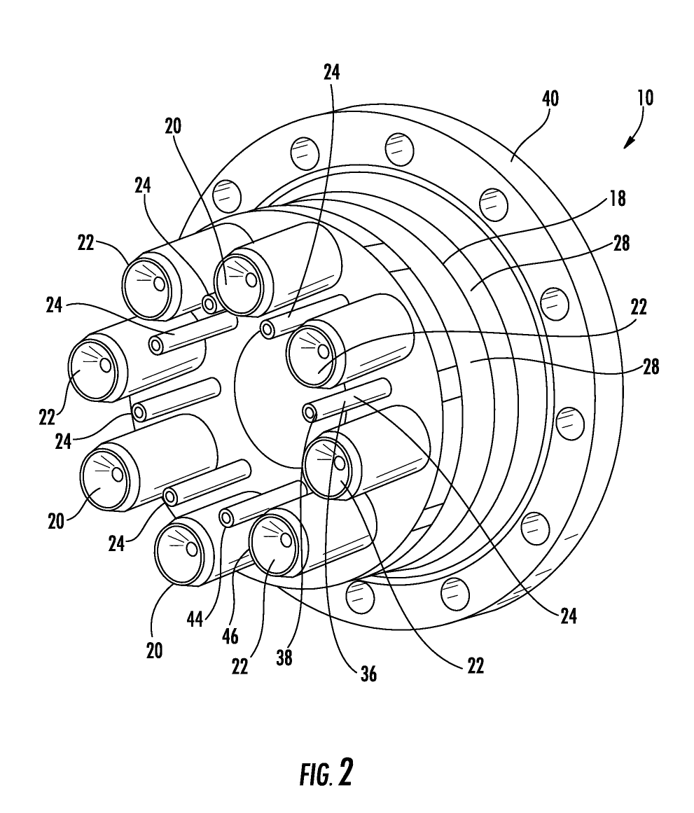

As shown in FIGS. 1-3, a fuel system 10 for a gas turbine engine 12 that improves efficiency by supplying fuel to a main stage 14 and secondary stage 16 via a common fuel source 18 is disclosed. The fuel system 10 may be formed from first and second primary injector assembly stages 20, 22 and a first premix injector assembly stage 24 positioned upstream from a combustor chamber 26, whereby the first premix injector assembly stage 24 is a secondary injector system. The second primary injector assembly stage 22 and the first premix injector assembly stage 24 may be in fluid communication with the same fuel source 18 to eliminate duplicative components found within systems where fuel is supplied individually to the second primary injector assembly stage 22 and the first premix injector assembly stage 24. The fuel system 10 may also be configured such that first premix injector assembly stage 24 need not be formed from custom fit parts installed during engine assembly. Rather, the fuel system 10 may be formed without such components. In at least one embodiment, the second primary injector assembly stage 22 and the first premix injector assembly stage 24 may each be in communication with a fuel manifold 28 configured to supply more fuel to the second primary injector assembly stage 22 than the first premix injector assembly stage 24.

In at least one embodiment, the fuel system 10 may be formed from a first primary injector assembly stage 20 including one or more injectors 30 positioned in a combustor 32. The first primary injector assembly stage 20 may be a first main injector system. The first primary injector assembly stage 20 may have any appropriate number of injectors 30, such as, but not limited to, between one and 16 injectors 30. The fuel system 10 may include a second primary injector assembly stage 22 formed from one or more injectors 34 positioned in the combustor 32. The second primary injector assembly stage 22 may be a second main injector system. The second primary injector assembly stage 22 may have any appropriate number of injectors 34, such as, but not limited to, between one and 16 injectors 34. The first and second primary injector assembly stages 20, 22 may be coupled to different fuel sources.

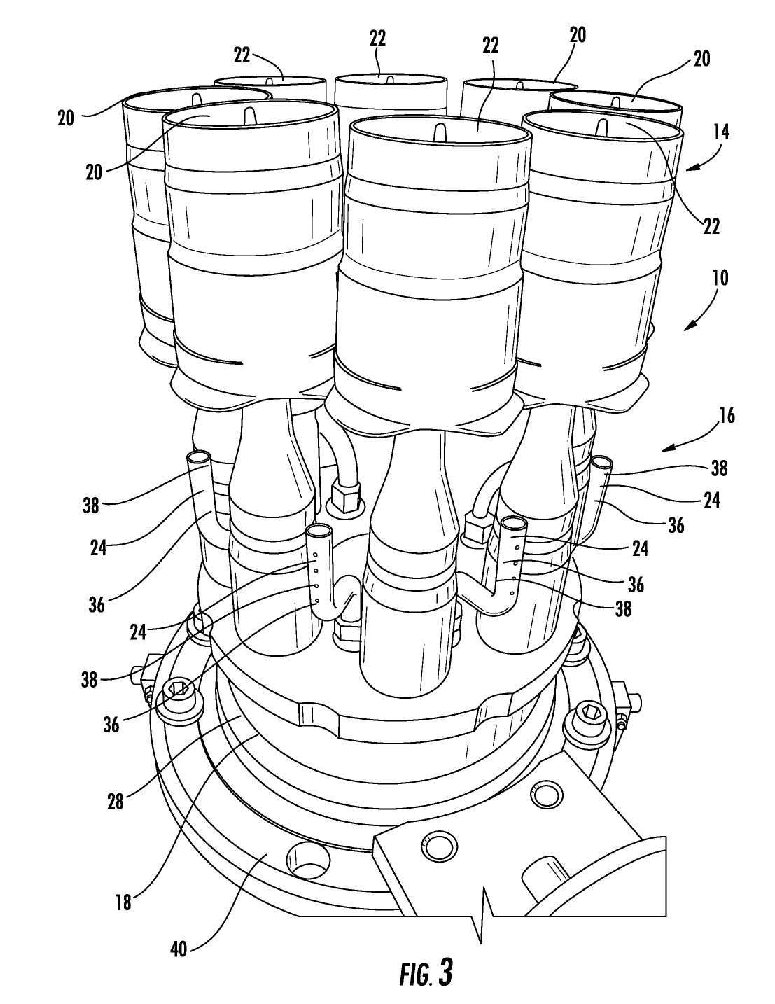

The fuel system 10 may also include one or more first premix injector assembly stages 24 formed from one or more injectors 36 positioned in the combustor 32 and in fluid communication with a fuel source 18 that also supplies fuel to the second primary injector assembly stage 22. The first premix injector assembly stage 24 may be a secondary injector system. The first premix injector assembly stage 24 may include one or more fuel injectors 36 extending into a combustor chamber 26 within the combustor 32. The fuel injector 36 may be a fuel injector peg 38 that is in fluid communication with the fuel supply manifold 28. The fuel injector peg 38 may extend from a support housing 40 containing the fuel supply manifold 28. The fuel injector peg 38 may be cylindrical or have another shape. The fuel injector peg 38 may be linear, curved, as shown in FIG. 3, or have any configuration. In at least one embodiment, the support housing 40 may be a generally cylindrical housing positioned at an upstream end of the combustor 32. In at least one embodiment, the first premix injector assembly stage 24 may include at least six fuel injector pegs 38 extending from the support housing 40 containing the fuel supply manifold 28 into the combustor chamber 26. In other embodiment, another number of fuel injector pegs 38, either higher or lower, may be used. The fuel injector pegs 38 may be positioned in a circumferential array extending downstream from the support housing 40. The fuel injector pegs 38 may be separated by injectors 34 forming the second primary injector assembly stage 22. In at least one embodiment, a downstream end 44 of the injectors 36 of the first premix injector assembly stage 24 may terminate upstream of a downstream end 46 of the injectors 34 of the second primary injector assembly stage 22. The fuel injector 36 of the first premix injector assembly stage 24 may be positioned upstream from a fuel swirler 42. The fuel swirler 42 may be positioned within the combustor chamber 26 and may be formed from any appropriate configuration.

The first premix injector assembly stage 24 and the second primary injector assembly stag 22 may be coupled together such that the fuel system 10 is capable of emitting fuel into the combustor 32 of the turbine engine 12 via the first premix injector assembly stage 24 and the second primary injector assembly stage 22 simultaneously. In at least one embodiment, the second primary injector assembly stage 22 may be in fluid communication with the fuel supply manifold 28, and the first premix injector assembly stage 24 may be in fluid communication with the fuel supply manifold 28. In at least one embodiment, the first primary injector assembly stage 20 may not be coupled to the fuel supply manifold 28. The fuel supply manifold 28 may be configured to supply less fuel to the first premix injector assembly stage 24 than the second primary injector assembly stage 22.

During operation, the combined primary and secondary fuel injector assembly stages 14, 16, such as the first premix injector assembly stage 24 and the second primary injector assembly stage 22, may be activated at the same time and operated through the engine loads. The fuel may be supplied from the fuel supply manifold 28 to the first premix injector assembly stage 24 and the second primary injector assembly stage 22 simultaneously. The fuel to the first premix injector assembly stage 24 may be throttled via the fuel supply manifold 28 such that the fuel supplied to the first premix injector assembly stage 24 is less than the fuel supplied to the second primary injector assembly stage 22 from the fuel supply manifold 28. The first primary injector assembly stage 20 may or may not fire simultaneously with the second primary injector assembly stage 22 and the first premix injector assembly stage 24. The first primary injector assembly stage 20 may be supplied with fuel from a fuel source other than the fuel supply manifold 28. In embodiments including a pilot stage 48, the pilot stage 48 may be supplied with fuel from a fuel source other than the fuel supply manifold 28.

The foregoing is provided for purposes of illustrating, explaining, and describing embodiments of this invention. Modifications and adaptations to these embodiments will be apparent to those skilled in the art and may be made without departing from the scope or spirit of this invention.

12. A fuel system for a turbine engine, comprising:
a first primary injector assembly stage comprising at least one injector positioned in a combustor, wherein the first primary injector assembly stage is a first main injector system;
a second primary injector assembly stage comprising at least one injector positioned in the combustor, wherein the second primary injector assembly stage is a second main injector system;
a first premix injector assembly stage comprising at least one injector positioned in the combustor and in fluid communication with a fuel source that also supplies fuel to at least the second primary injector assembly stage, wherein the first premix injector assembly stage is a secondary injector system; and
wherein the first premix injector assembly stage and the second primary injector assembly stage are coupled together such that the fuel system is capable of emitting fuel into the combustor of the turbine engine via the first premix injector assembly stage and the second primary injector assembly stage simultaneously.

13. The fuel system of claim 12, wherein the second primary injector assembly stage is in fluid communication with a fuel supply manifold, and the first premix injector assembly stage is in fluid communication with the fuel supply manifold.

14. The fuel system of claim 13, wherein the fuel supply manifold is configured to supply less fuel to the first premix injector assembly stage than the second primary injector assembly stage.

15. The fuel system of claim 12, wherein the first premix injector assembly stage includes at least one fuel injector extending into a combustor chamber within the combustor.

16. The fuel system of claim 15, wherein the at least one fuel injector is a fuel injector peg that is in fluid communication with a fuel supply manifold.

17. The fuel system of claim 16, wherein the at least one fuel injector peg extends from a support housing containing the fuel supply manifold.

18. The fuel system of claim 17, wherein the at least one fuel injector peg comprises at least six fuel injector pegs extending from the support housing containing the fuel supply manifold into the combustor chamber.

19. The fuel system of claim 18, wherein the fuel injector pegs are positioned in a circumferential array extending downstream from the support housing.

20. The fuel system of claim 18, wherein the fuel injector pegs are separated by injectors forming the second primary injector assembly stage.

21. The fuel system of claim 12, wherein the at least one injector of the first premix injector assembly stage is positioned upstream from a fuel swirler.

22. The fuel system of claim 12, wherein a downstream end of the at least one injector of the first premix injector assembly stage terminates upstream of a downstream end of the at least one injector of the second primary injector assembly stage.

23. A fuel system for a turbine engine, comprising:
a first primary injector assembly stage comprising at least one injector positioned in a combustor, wherein the first primary injector assembly stage is a first main injector system;
a second primary injector assembly stage comprising at least one injector positioned in the combustor, wherein the second primary injector assembly stage is a second main injector system and is in communication with a fuel supply manifold;
a first premix injector assembly stage comprising at least one injector peg positioned in the combustor and in fluid communication with the fuel supply manifold that also supplies fuel to at least the second primary injector assembly stage, wherein the first premix injector assembly stage is a secondary injector system;
wherein the first premix injector assembly stage and the second primary injector assembly stage are coupled together such that the fuel system is capable of emitting fuel into a combustor chamber of the turbine engine via the first premix injector assembly stage and the second primary injector assembly stage simultaneously and supplying less fuel to the first premix injector assembly stage than the second primary injector assembly stage; and
wherein the at least one injector of the first premix injector assembly stage is positioned upstream from a fuel swirler in the combustor chamber.

24. The fuel system of claim 23, wherein the at least one fuel injector is a fuel injector peg that is in fluid communication with a fuel supply manifold.

25. The fuel system of claim 24, wherein the at least one fuel injector peg extends from a support housing containing the fuel supply manifold.

26. The fuel system of claim 25, wherein the at least one fuel injector peg comprises at least six fuel injector pegs extending from the support housing containing the fuel supply manifold into the combustor chamber.

27. The fuel system of claim 26, wherein the fuel injector pegs are positioned in a circumferential array extending downstream from the support housing.

28. The fuel system of claim 26, wherein the fuel injector pegs are separated by injectors forming the second primary injector assembly stage.

29. The fuel system of claim 12, wherein a downstream end of the at least one injector of the first premix injector assembly stage terminates upstream of a downstream end of the at least one injector of the second primary injector assembly stage.

30. A fuel system for a turbine engine, comprising:
a first primary injector assembly stage comprising at least one injector positioned in a combustor, wherein the first primary injector assembly stage is a first main injector system;
a second primary injector assembly stage comprising at least one injector positioned in the combustor, wherein the second primary injector assembly stage is a second main injector system and is in communication with a fuel supply manifold;
a first premix injector assembly stage comprising at least one injector peg positioned in the combustor and in fluid communication with the fuel supply manifold that also supplies fuel to at least the second primary injector assembly stage, wherein the first premix injector assembly stage is a secondary injector system;
wherein the first premix injector assembly stage and the second primary injector assembly stage are coupled together such that the fuel system is capable of emitting fuel into the combustor chamber of the turbine engine via the first premix injector assembly stage and the second primary injector assembly stage simultaneously and supplying less fuel to the first premix injector assembly stage than the second primary injector assembly stage;
wherein the at least one injector of the first premix injector assembly stage is positioned upstream from a fuel swirler in the combustor chamber;
wherein the first premix injector assembly stage includes at least one fuel injector extending into the combustor chamber within the combustor;
wherein the at least one fuel injector is a fuel injector peg that is in fluid communication with a fuel supply manifold and extends from a support housing containing the fuel supply manifold; and
wherein the fuel injector pegs are positioned in a circumferential array extending downstream from the support housing.

31. The fuel system of claim 30, wherein the fuel injector pegs are separated by injectors forming the second primary injector assembly stage.
